(19) United States
(12) Patent Application Publication
(10) Pub. No.: US 2009/0123750 A1
(43) Pub. Date: May 14, 2009

(54) Method for modifying carbon nanotube

(76) Inventors: Chia-Hsun Chen, Taichung City (TW); Chen-Feng Kuan, Houli Township (TW); Hsu-Chiang Kuan, Kaohsiung City (TW); Kun-Chang Lin, Tainan City (TW); Min-Chi Chung, Houli Township (TW); Hsin-Chin Peng, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/979,854

(22) Filed: Nov. 9, 2007

(51) Int. Cl. C09C 1/44; B05D 1/18; B05D 3/02

(52) U.S. Cl. 428/378; 427/443.2; 427/372.2; 977/742

(57) ABSTRACT

A method for modifying CNT is disclosed. The modified CNT by the above-mentioned method mixed with a resin is provided with an enhanced diffusibility; therefore the electronic property and mechanical property of resin are enhanced obviously with lower quantity of CNT.

### FIELD OF THE INVENTION

The present invention is related to a method for modifying carbon nanotubes (CNT), and more particularly to a method for coinciding an organic group to the surface of carbon nanotubes (CNT).

### DESCRIPTION OF THE PRIOR ART

Carbon NanoTubes (CNT) is provided with very particular properties, such as low density, high strength, high tenacity, large surface area, high surface curvatures, high heat conductivity, excellent electronic conductivity and so on, so it has attracted lots of research workers to concentrate their attention on developing possibly applied area, such as the composite material, the microelectronic material, the plane monitor, wireless communication, the fuel cell, a lithium batter and so on. Among them, composite materials application is the greatest field for requirement and application of carbon nanotubes. For example, immersing CNT in a plastic material may efficiently enhance the Electromagnetic interference (EMD protective effect of the plastic material.

EMI is related to the interference from energy radiation when using electronic apparatus, such as a microwave oven and a personal computer etc. . . . The radiation of EMI may result in the noise and interference between electronic apparatus, and influence the normal operation of wireless device, experimental instrument, man-made heart and so on. The advanced countries in the world have drawn up a standard on a permit of the EMI from electronic apparatus.

Generally, the radiation of EMI may be eliminated by forming a cover layer with low impedance on electronic apparatus or facilities. With regard to common methods of sheltering general nonconductors from EMI, it includes that to forming a metal layer on the plastic shell of electronic facilities, for example, paint spraying, chemical metallic, vacuum metallic or covered with a metal foil directly. However, the microminiaturized electronic facilities may not be satisfied with the adhesive force, accuracy and shelter ability of the EMI shelter layer formed by thus methods. Therefore, if a plastic material with low resistance (high electric conductivity) is provided to manufacture electronic elements or shell of facilities, it will help to enhance the efficiency of the layer covered from EMI.

Though we can achieve the above-mentioned efficiency by immersing CNT in plastic material. However, CNT sold in gram by unit is extremely expensive material. It's an urgent problem that not only reducing the content of CNT but also achieving the expected efficiency.

In view of the shortcomings of the prior art, the inventor of the present invention based on years of experience in the CNT to conduct experiments and modifications, and finally developed a method for modifying carbon nanotubes to overcome the foregoing shortcomings.

### SUMMARY OF THE INVENTION

The primary purpose of the present invention is to provide a method for modifying carbon nanotubes (CNT). The CNT modified with thus method mixed with a resin is provided with an enhanced diffusibility, thus the better electronic property and mechanical property of resin are gained obviously with lower quantity of CNT.

A method to modify CNT involving the following steps:
a). Providing an unmodified CNT, a organic group and a free-radical initiator
b). Mixing the organic group and a free-radical initiator with the unmodified CNT in a solvent in order to proceed reaction;
c). Vaporizing and removing the residual solvent
d). Washing the solid part and Drying by heat to obtain a modified CNT product.

The CNT modified by the above-mentioned method include CNT and organic group coincided to the surface of CNT.

To make it easier for our examiner to understand the objective of the invention, its structure, innovative features, and performance, we use preferred embodiments together with the attached drawings for the detailed description of the invention.

### BRIEF DESCRIPTION OF THE DRAWINGS

FIG. 1 is a process flow chart of a method for modifying CNT in accordance with the present invention;

FIG. 2 is a chemical combined schematic view showing a method for modifying CNT in accordance with the present invention;

FIG. 3 is an infrared ray spectrogram of the modified CNT of the present invention and pure carbon nanotubes;

FIG. 4 is a infrared ray spectrogram of a organic group, maleic acid anhydride (MA); and

FIG. 5 is a chemical combination schematic view showing a method for modifying CNT in accordance with the present invention.

### DETAILED DESCRIPTION OF THE PREFERRED EMBODIMENTS

In the related figures of a preferred embodiment, the same referring numerals are used for the same components of an input apparatus in accordance with the present invention.

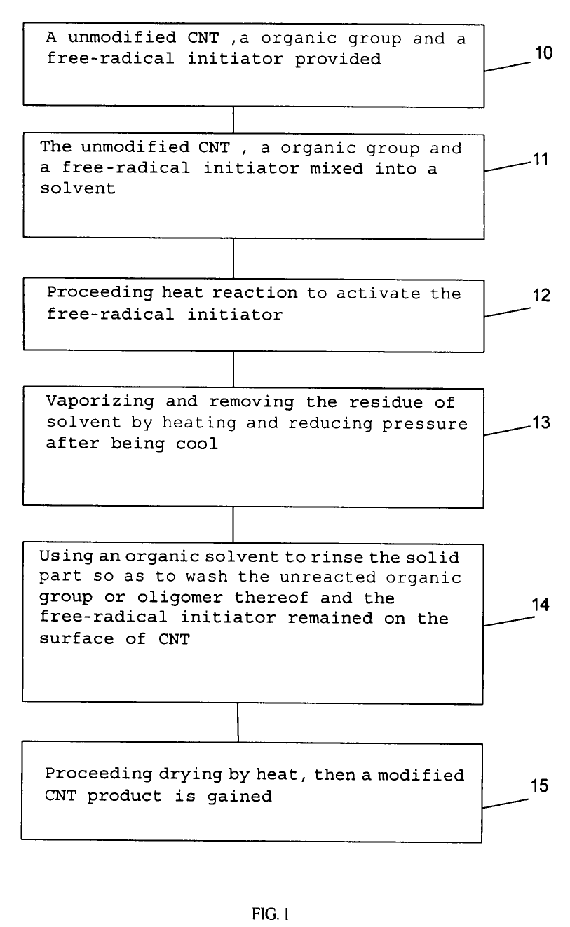

As illustrated in FIG. 1 for a process flow chart of a method for modifying CNT on accordance with the present invention, the method includes the following steps:

Step 10: A unmodified CNT, an organic group and a free-radical initiator are provided, wherein the CNT also include carbon nanowires, single-walled CNT and multi-walled CNT. These CNT are suitable for the present invention. The manufacture technique of CNT proceeding in chemical vapor deposition (CVD) is known by the manufacturing industries generally, and there are commercial CNT sold at mart. Of the preferred embodiment of the present invention, the commercial CNT bought at mart are adapted.

Furthermore, the organic group may be a vinyl-nonsaturated monomer which may be related to ethene, propylene, vinylamine, maleic acid and its anhydride, fumaric acid, acrylic acid and its anhydride, methyl acrylic acid, acrylic ester and methyl acrylic ester; or it may also be a organic-nonsaturated silane which may be related to ethane, propane, 2-methylpropane, pentane and 2-methylbutane, and a free-radical initiator may be a azo-compound or a peroxide.

Step. 11: Mixing the unmodified CNT, organic group and free-radical initiator in a solvent, wherein the solvent may be one or mixture of acetone tetrahydrofuran (THF), N-methyl-2pyrrolidone (NMP), N,N-dimethylacetamide (DMAc), dimethylformamide (DMF), dimethylsulfoxide (DMSO), m-cresol, pyridine (PY), methylchloride, ethylchloride, benzene, xylene and chlorobenzene.

Step. 12: Performing a heating reaction to activate the free-radical initiator, wherein the temperature preferred between 60-95° C., and the proper time preferred between 0.5 hr-10 hrs.

Step. 13: After cooling, the residual solvent after reaction is vaporized or removed by heating or reducing pressure.

Step. 14: Rinsing the solid part with a organic solvent to remove the unreacted organic group or oligomer thereof and free-radical initiator remained on the surface of CNT, wherein the organic solvent is preferred to one or mixture of acetone, tetrahydrofuran (THF), N-methyl-2pyrrolidone (NMP), N,N-dimethylacetamide (DMAc), dimethylformamide (DMF), dimethylsulfoxide (DMSO), m-cresol, pyridine (PY), methylchloride, ethylchloride, benzene, xylene and chlorobenzene.

Step. 15: Heating the solid part to obtain a modified CNT.

The modified CNT by the above-mentioned method mixed with a resin is provided with an enhanced diffusibility; therefore the electronic property and mechanical property of resin are enhanced obviously with lower quantity of CNT.

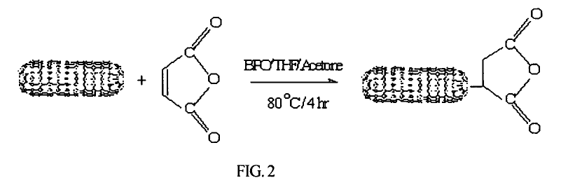

Referring to FIG. 2 for a chemical combination of a preferred embodiment of a modified CNT in accordance with present invention, an unmodified CNT, a maleic acid anhydride and a BPO free-radical initiator are putted together into a mixed solvent of acetone and THF. After reflux reaction for 4 hours at 80° C., the residual mixture after reaction are vaporized or removed by heating and pressure reduction. A modified CNT is then obtained after the reaction compound is dried by heat.

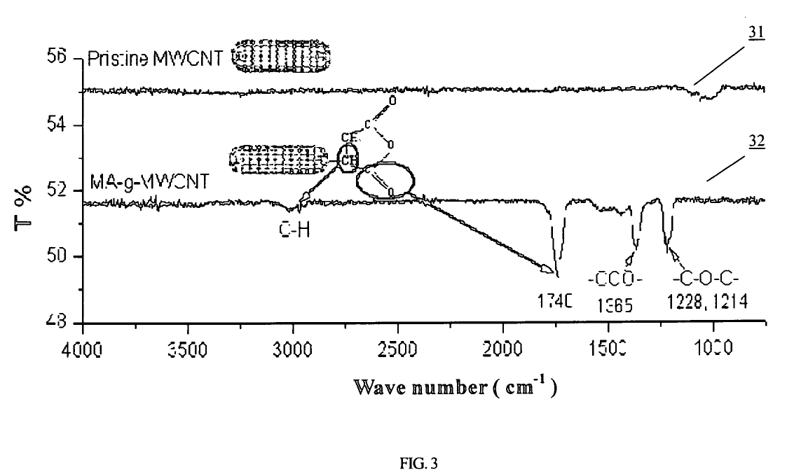

Referring to FIG. 3 for an infrared ray spectrogram of the modified CNT in accordance with the present invention and pure carbon nanotubes, the infrared ray spectrum 31 of pure CNT is not provided with an obvious functionality absorbed peak. But three functionality characteristic absorbed peaks are obviously observed in the infrared ray spectrum 32 of modified CNT, the characteristic absorbed peak of functionality —C—O—C— is appeared at 1214 cm⁻¹ to 1228 cm⁻¹ nearby, the characteristic absorbed peak of functionality —COO is appeared at 1365 cm⁻¹ nearby and the characteristic absorbed peak of functionality —C═O is appeared at 1740 cm⁻¹ nearby. Hence, CNT bonding with maleic anhydride are confirmed by the infrared ray spectrum.

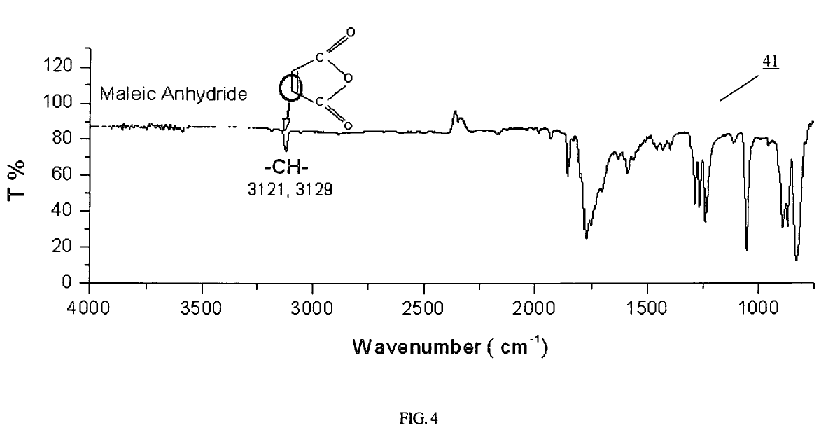

Referring to FIG. 4 for an infrared ray spectrogram of a organic group, maleic acid anhydride (MA), a characteristic absorbed peak of —CH bond which of C═C double bond of MA functionality is observed obviously at 3121 cm⁻¹ and 3129 cm⁻¹ nearby of the infrared ray spectrum 41 of the organic group, maleic anhydride.

And as the showing of FIG. 3, the characteristic absorbed peak isn't appeared at the infrared spectrum 32 of modified CNT, but the —CH characteristic absorbed peak of C═C MA functionality is appeared at 3000 cm⁻¹ nearby instead. Hence, it proved that the original —CH on C═C of MA functionality is disappeared, and the CNT has been bonding with Maleic anhydride.

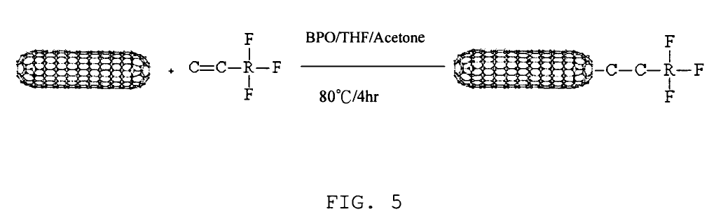

Please referring to FIG. 5 for another chemical combination of a preferred embodiment of method for modifying CNT in accordance with present invention, a unmodified CNT, a BPO free-radical initiator and a organic unsaturated silane which of general formula showed as RSiF₃ which R is related to C═C, F is related to alkane group are putted together into a mixed solvent of acetone and THF. Next, after a reflux reaction for 4 hours, the residual solvent is vaporized and removed by heating or pressure reduction. After that, a modified CNT is gained after the reaction compound is dried by heat.

It is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

What is claimed is:

1. A modified carbon nanotubes (CNT) comprising a CNT and an organic group coincided to a surface of said CNT.

2. The modified CNT as claimed in claim 1, wherein said organic group is related to a residue remained from an unsaturated vinyl-group having a covalent bond with said CNT of vinyl-unsaturated monomer activated by a free-radical initiator.

3. The modified CNT as claimed in claim 1, wherein said organic group is related to a residue remained from an organic unsaturated silane having a covalent bond with said CNT activated by a free-radical initiator.

4. The modified CNT as claimed in claim 2, wherein said vinyl-unsaturated monomer includes ethane, propylene, maleic acid and its anhydride, fumaric acid, acrylic acid and its anhydride, methylacrylic acid, acrylic ester, methylacrylic ester or silane with double bonding.

5. The modified CNT as claimed in claim 3, wherein said organic unsaturated silane includes ethane propane 2-methylpropane pentane 2-methylbutane.

6. The modified CNT as claimed in claim 2 and claim 3, wherein said free-radical initiator is related to azo-compound or peroxide.

7. A method for modifying a CNT comprising the steps of:
immersing a CNT and a vinyl-unsaturated monomer or organic unsaturated silane in a solvent with existence of a free-radical initiator for a proceeding reaction to lead to at least a part of said vinyl-unsaturated monomer and a part of said organic unsaturated silane being linked with said CNT.

8. The method as claimed in claim 7, further comprising a step of vaporizing and removing said solvent of said compound to obtain a dry solid part.

9. The method as claimed in claim 7, further comprising a step of using an organic solvent to rinse the solid part so as to wash said free-radical initiator, and an unreacted vinyl-unsaturated monomer, an oligomer thereof or said organic unsaturated silane remained on surface of said CNT.

10. The method as claimed in claim 9, further comprising a step of vaporizing and removing said organic solvent from said washed solid part to obtain said modified.

11. The method as claimed in claim 7, wherein said vinyl-unsaturated monomer includes ethene, propylene, vinylamine, maleic acid and its anhydride, fumaric acids acrylic acid and its anhydride, methylacrylic acids acrylic ester and methylacrylic ester.

12. The method as claimed in claim 7, wherein said unsaturated silane includes ethane, propylene, 2-methylpropane, pentane, 2-methylbutane.

13. The method as claimed in claim 7, wherein said free-radical initiator is related to azo-compound or peroxide.

14. The method as claimed in claim 7, wherein said solvent is related to one or mixtures of acetone, tetrahydrofuran (THF), N-methyl-2pyrrolidone (NMP), N,N-dimethylacetamide (DMAc), dimethylformamide (DMF), dimethylsulfoxide (DMSO), m-cresol, pyridine (PY), methylchloride, ethylchloride, benzene, xylene and chlorobenzene.

15. The method as claimed in claim 7, wherein said reaction proceeds for 0.5 hour-10 hours at 60-95° C.

16. The method as claimed in claim 8, wherein said step of vaporizing and removing of the solvent is accomplished by heating and pressure reduction.

17. The method as claimed in claim 7, wherein said solvent is related to one or mixtures of acetone, tetrahydrofuran (THF), N-methyl-2pyrrolidone (NMP), N,N-dimethylacetamide (DMAc), dimethylformamide (DMF), dimethylsulfoxide (DMSO), m-cresol, pyridine (Py), methylchloride, ethylchloride, benzene, xylene and chlorobenzene.

18. The method as claimed in claim 10, wherein said step of vaporizing and removing of the solvent is done by heating and pressure reduction.
